(19) United States
(12) Patent Application Publication
(10) Pub. No.: US 2021/0029643 A1
(43) Pub. Date: Jan. 28, 2021

(54) 5G NR Fast Low-Power Mode

(71) Applicant: Google LLC, Mountain View, CA (US)

(72) Inventors: Erik Richard Stauffer, Sunnyvale, CA (US); Jibing Wang, San Jose, CA (US)

(73) Assignee: Google LLC, Mountain View, CA (US)

(21) Appl. No.: 17/042,750

(22) PCT Filed: Apr. 17, 2019
(86) PCT No.: PCT/US2019/027974

§ 371 Date: Sep. 28, 2020

Related U.S. Application Data
(60) Provisional application No. 62/686,506, filed on Jun. 18, 2018.

(51) Int. Cl. H04W 52/02; H04W 80/02; H04W 28/02; H04W 76/27; H04W 72/04

(52) U.S. Cl. CPC H04W 52/0277; H04W 52/0229; H04W 72/0413; H04W 28/0221; H04W 76/27; H04W 80/02

(57) ABSTRACT

The present disclosure describes techniques and systems for 5G NR fast low-power mode. These techniques enable a user equipment (UE) (102) to autonomously trigger a fast low-power mode (FLPM) to reduce power consumption at the UE. In some aspects, the UE (102) transmits (308) an uplink (UL) signal that includes an FLPM request message to a base station (104). The FLPM request message requests permission for the UE (102) to enter a radio resource control (RRC) idle mode. The UE (102) detects (310) a downlink (DL) signal that includes an FLPM acknowledgment from the base station (104). The DL signal includes instructions to direct the UE to instead enter an RRC_inactive mode. In response, the UE (102) initiates (312) the RRC_inactive mode. To conserve additional power, the UE (102) may request that certain communication types or sources be delayed while the UE (102) is in the low-power mode.

### BACKGROUND

Generally, a provider of a wireless network manages wireless communications over the wireless network. For example, a base station manages a wireless connection with a user device that is connected to the wireless network. The base station determines configurations for the wireless connection, such as bandwidth, timing, and protocol for the wireless connection. The base station then transmits control messages to the user device to instruct the user device of the configurations for the wireless connection. Allowing the base station to determine the configurations for the wireless connection allows the base station to manage wireless connections with many wireless devices. However, without information related to conditions at the user device, the base station may choose suboptimal configurations for the wireless connection between the base station and the user device.

With recent advances in wireless communication technology, providers also have access to higher-frequency radio spectrum, relative to conventional wireless deployments. This access coupled with other technologies enables the base station to provide wireless connections with wider bandwidth, lower latency, and increased data rates. With suboptimal configurations, however, these wireless connections with wider bandwidths and at higher frequency bands may cause user equipment to consume excessive power relative to conventional wireless deployments.

### SUMMARY

This document describes techniques and apparatuses for a Fifth Generation New Radio (5G NR) fast low-power mode. These techniques enable a user equipment (UE) to request to enter a fast low-power mode (FLPM) to reduce power consumption at the UE. In conventional cellular wireless networks, such as Long Term Evolution (LTE) and LTE-Advanced (LTE-A), the base station dictates selection of a power mode in which the UE operates with regard to communications (e.g., transmissions) over a network. However, there may be instances when the UE could benefit from operating in a lower power mode rather than the base station-selected power mode.

In an example, the user device can autonomously provide, to the base station, a request to enter a low-power mode based on local factors, such as a low battery power level or a high temperature of the UE. The base station can receive the request and dictate a change in the power mode of the UE to a low-power mode to reduce power consumption, conserve battery life, and/or decrease the UE temperature. Alternatively, the request can be sent based on a user input selecting a particular power mode and the base station can honor that request by causing the UE to enter the particular power mode. In this way, flexibility is provided to the UE (and the user of the UE) to change the power mode of the UE to reduce power consumption.

The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

The details of one or more aspects of 5G NR fast low-power mode is described below. The use of the same reference numbers in different instances in the description and the figures indicate similar elements:

FIG. 1 illustrates an example operating environment in which a 5G NR fast low-power mode can be implemented.

FIG. 2 illustrates an example device diagram of a user equipment and a serving cell base station.

FIG. 3 depicts an example method of autonomously triggering a fast low-power mode at a UE in accordance with aspects of the techniques described herein.

FIG. 4 depicts an example method of triggering a fast low-power mode at a UE in accordance with aspects of the techniques described herein.

FIG. 5 illustrates an example communication device that can be implemented as the user equipment in accordance with one or more aspects of 5G NR fast low-power mode as described herein,

### DETAILED DESCRIPTION

Base stations of wireless networks manage wireless connections with user equipments (UEs) by scheduling communication resources and determining configurations by which the user devices communicate. However, the base station typically determines the configurations for the wireless connection without information related to conditions at the user device, which may lead to excessive UE power consumption. For example, the base station may configure a power mode (e.g., connected mode) for UE without data related to or available at the UE, such as a battery level or thermal state of the UE. This can result in excess transmission power levels, which can consume excessive power or generate additional heat at the UE.

This document describes techniques and systems for a 5G NR fast low-power mode. These techniques include a UE triggering a fast low-power mode (FLPM), based on one or more local factors, by sending a message to the base station that requests a particular low-power mode, such as an inactive mode (e.g., RCC_inactive) or an idle mode (e.g., RCC_idle). The base station can receive the request and, based on the request, adjust the power mode of the UE, such as by placing the UE in the inactive mode or the idle mode. These techniques provide flexibility to the UE to initiate a low-power mode based on its own local state, which can reduce power consumption.

In addition, the UE can indicate in the FLPM request a priority level for specific types of communications (e.g., voice call, short message service (SMS) message, emergency call) or sources (e.g., spouse, employer, hospital) that should wake the UE from the inactive or idle mode. Transmissions associated with other types of communications or sources with lower priority may be delayed for a period of time. Allowing a user to prioritize communication types and sources that may wake the UE from a low-power mode can reduce unnecessary power consumption by waking the UE less frequently.

This summary is provided to introduce simplified concepts of a 5G NR fast low-power mode. The simplified concepts are further described below in the Detailed Description. This summary is not intended to identify essential features of the claimed subject matter, nor is it intended for use in determining the scope of the claimed subject matter.

### Operating Environment

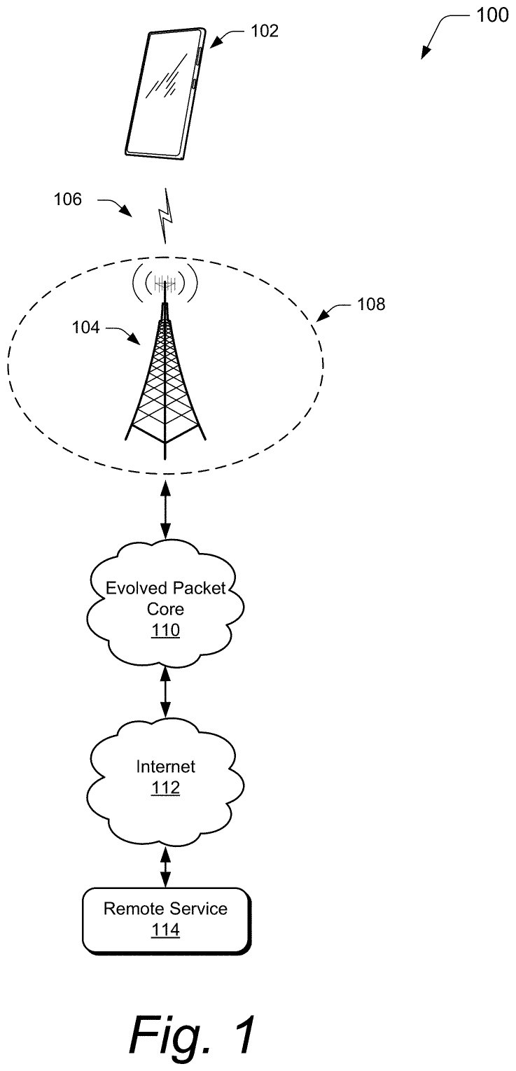

FIG. 1 illustrates an example environment 100 which includes a user equipment 102 that communicates with a base station 104 that acts as a serving cell, (serving cell base station 104), through a wireless communication link 106 (wireless link 106). In this example, the user equipment 102 is implemented as a smailphone. Although illustrated as a smailphone, the user equipment 102 may be implemented as any suitable computing or electronic device, such as a mobile communication device, a modem, cellular phone, gaming device, navigation device, media device, laptop computer, desktop computer, tablet computer, smart appliance, vehicle-based communication system, and the like. The base station 104 may be implemented as or include an Evolved Universal Terrestrial Radio Access Network (E-UTRAN), evolved Node B (eNodeB or eNB), a Next Generation Node B (gNodeB or gNB), a long-term evolution (LTE) system, an LTE-Advanced (LTE-A) system, an evolution of the LTE-A system, a 5G NR system, and the like. When implemented as part of a wireless network, the base station 104 may be configured to provide or support a macrocell, microcell, small cell, picocell, wide-area network, or any combination thereof In various aspects of 5G NR fast low-power mode, the base station 104 may be referred to as an eNB, a gNB, or relay (or vice versa).

The serving cell base station 104 communicates with the user equipment 102 via the wireless link 106, which may be implemented as any suitable type of wireless link. The wireless link 106 can include a downlink of data and control information communicated from the serving cell base station 104 to the user equipment 102 and/or an uplink of other data and control information communicated from the user equipment 102 to the serving cell base station 104. The wireless link 106 may include one or more wireless links or bearers implemented using any suitable communication protocol or standard, or combination of communication protocols or standards such as 3rd Generation Partnership Project Long-Term Evolution (3GPP LTE), 5G NR, and so forth.

The serving cell base station 104 may be part of a Radio Access Network 108 (RAN 108, Evolved Universal Terrestrial Radio Access Network 108, E-UTRAN 108), which is connected via an Evolved Packet Core 110 (EPC 110) network to form a wireless operator network. The UE 102 may connect, via the EPC 110, to public networks, such as the Internet 112 to interact with a remote service 114.

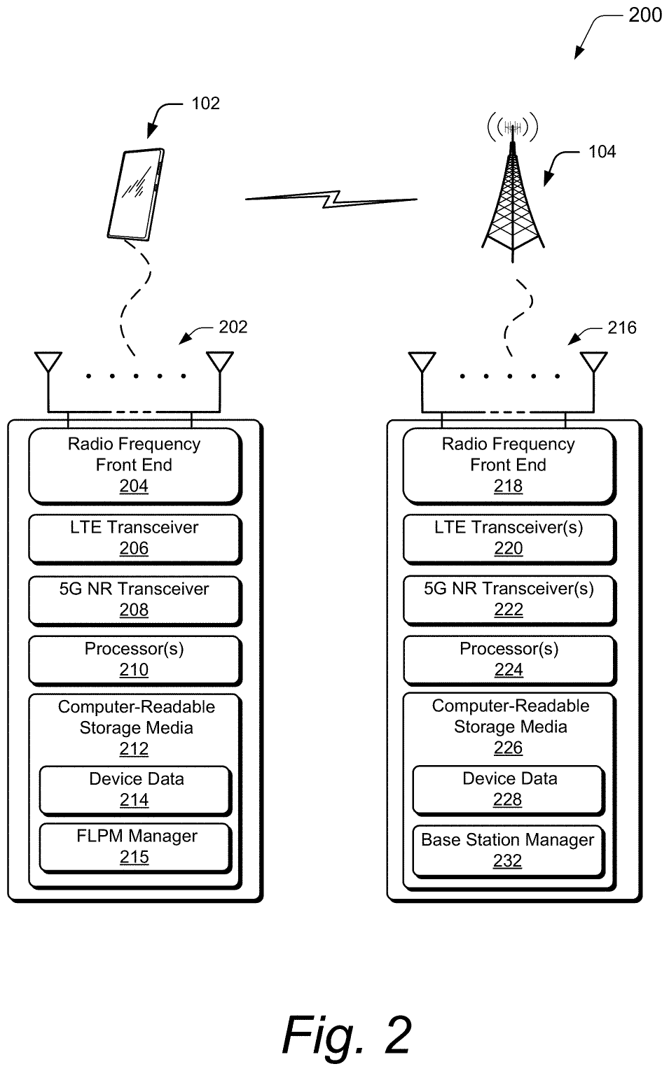

FIG. 2 illustrates an example device diagram 200 of the user equipment 102 and the serving cell base station 104. It should be noted that not all features of the user equipment 102 and the serving cell base station 104 are illustrated here for the sake of clarity. In other words, the user equipment 102 and/or serving base station 104 may also include any other suitable components to implement respective communication or processing functions of either device. In this example, the user equipment 102 includes antennas 202, a radio frequency front end 204 (RF front end 204), an LTE transceiver 206, and a 5G NR transceiver 208 for communicating with base stations 104 in the E-UTRAN 108. The RF front end 204 of the user equipment 102 can couple or connect the LTE transceiver 206, and the 5G NR transceiver 208 to the antennas 202 to facilitate various types or modes of wireless communication.

The antennas 202 of the user equipment 102 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. By way of example and not limitation, the antennas 202 and the RF front end 204 can be implemented for operation in sub-gigahertz bands, sub-6 GHZ bands, and/or above 6 GHz bands that are defined by the 3GPP LTE and 5G NR communication standards. Alternatively, the 5G NR transceiver 208 may be replaced with a 5G NR receiver (or transmitter) and operations describe herein as performed by the 5G NR transceiver 208 may performed by the 5G NR receiver (or transmitter).

The user equipment 102 also includes processor(s) 210 and computer-readable storage media 212 (CRM 212). The processor 210 may be a single core processor or a multiple core processor composed of a variety of materials, such as silicon, polysilicon, high-K dielectric, copper, and so on. The computer-readable storage media described herein excludes propagating signals or carrier waves. The CRM 212 may include any suitable memory or storage device such as subscriber identity module (SIM), random-access memory (RAM), static RAM (SRAM), dynamic RAM (DRAM), non-volatile RAM (NVRAM), read-only memory (ROM), Flash memory, hard disk, or optical data storage device useful to store device data 214 of the user equipment 102. The device data 214 includes user data, multimedia data, applications, and/or an operating system of the user equipment 102, which are executable by processor(s) 210 to enable user interaction with the user equipment 102 or functionalities thereof

CRM 212 also includes a fast low-power mode (FLPM) manager 215, which, in one implementation, is embodied on CRM 212 (as shown). Alternately or additionally, the FLPM manager 215 may be implemented in whole or part as hardware logic or circuitry integrated with or separate from other components of the user equipment 102. In at least some aspects, the FLPM manager 215 configures or acts via the RF front end 204, the LTE transceiver 206, and/or the 5G NR transceiver 208 to implement the techniques for 5G NR fast low power mode.

The device diagram for the serving cell base station 104 shown in FIG. 2 includes a single network node (e.g., an E-UTRAN Node B or gNodeB). The functionality of the serving cell base station 104 may be distributed across multiple network nodes and/or devices, and can be distributed in any fashion suitable to perform the functions described herein. In this example, the serving cell base station 104 includes antennas 216, a radio frequency front end 218 (RF front end 218), one or more LTE transceivers 220, and/or one or more 5G NR transceivers 222 for communicating with the user equipment 102. The RF front end 218 of the serving cell base station 104 can couple or connect the LTE transceivers 220 and the 5G NR transceivers 222 to the antennas 216 to facilitate various types of wireless communication.

The antennas 216 of the serving cell base station 104 may include an array of multiple antennas that are configured similar to or differently from each other. The antennas 216 and the RF front end 218 can be tuned to, and/or be tunable to, one or more frequency band defined by the 3GPP LTE and 5G NR communication standards, and implemented by the LTE transceivers 220, and/or the 5G NR transceivers 222. Additionally, the antennas 216, the RF front end 218, the LTE transceivers 220, and/or the 5G NR transceivers 222 may be configured to support beamforming, such as massive multiple input multiple output (mMIMO), for the transmission and reception of communications with the user equipment 102.

The serving cell base station 104 also includes processor(s) 224 and computer-readable storage media 226 (CRM 226). The processor 224 may be a single core processor or a multiple core processor composed of a variety of materials, such as silicon, polysilicon, high-K dielectric, copper, and so on. The CRM 226 may include any suitable memory or storage device such as random-access memory (RAM), static RAM (SRAM), dynamic RAM (DRAM), non-volatile RAM (NVRAM), read-only memory (ROM), or Flash memory useful to store device data 228 of the serving cell base station 104. The CRM 226 of the serving cell base station 104 is not configured to store propagating signals or carrier waves. The device data 228 includes network scheduling data, radio resource management data, applications, and/or an operating system of the serving cell base station 104, which are executable by processor(s) 224 to enable communication with the user equipment 102 or functionalities of the serving cell base station 104.

CRM 228 also includes a base station manager 232, which, in one implementation, is embodied on CRM 228 (as shown). Alternately or additionally, the base station manager 232 may be implemented in whole or part as hardware logic or circuitry integrated with or separate from other components of the serving cell base station 104. In at least some aspects, the base station manager 232 configures the LTE transceivers 222 and the 5G NR transceivers 224 for communication with the user equipment 102, as well as communication with the EPC 114.

### Example Procedures

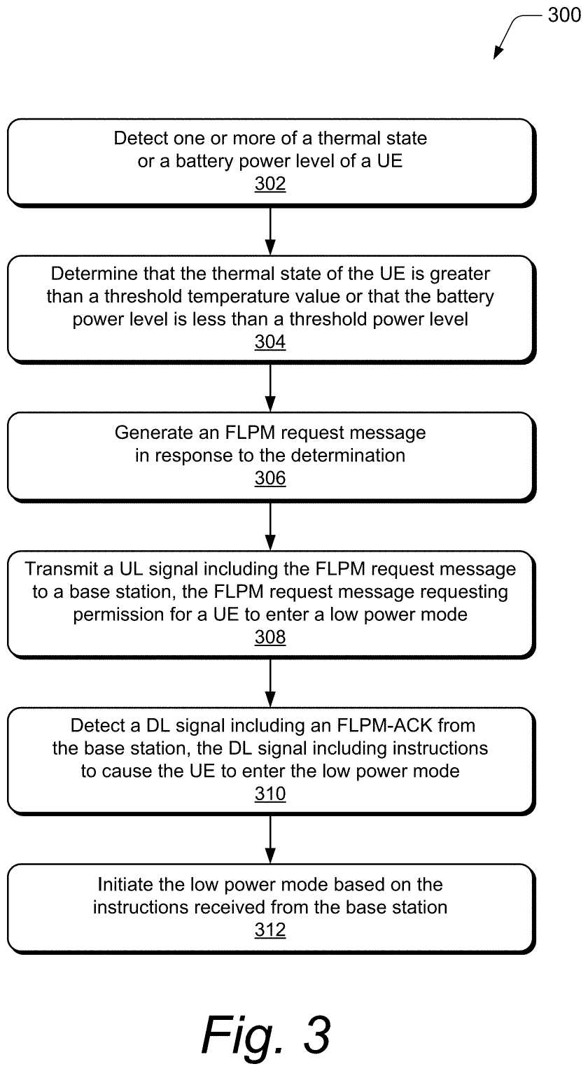

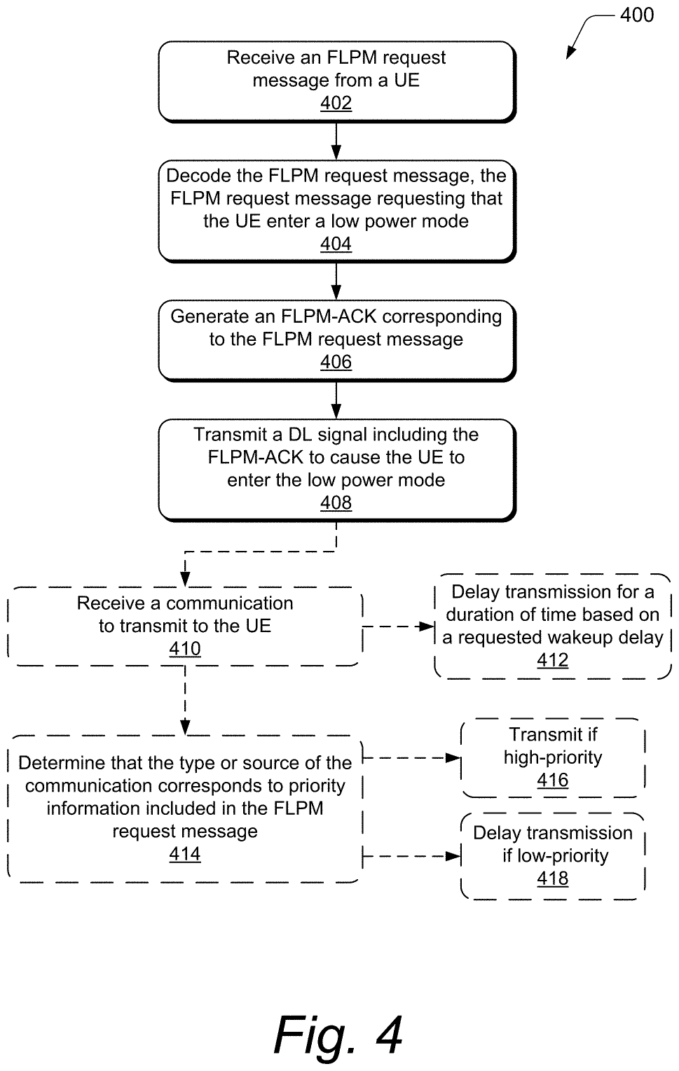

Example methods 300 and 400 are described with reference to FIGS. 3 and 4, respectively, in accordance with one or more aspects of a 5G NR fast low-power mode. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (AS SPs), System-on-a-chip systems (SoCs), Complex Programmable Logic Devices (CPLDs), and the like.

FIG. 3 depicts an example method 300 of autonomously triggering a fast low-power mode at a UE in accordance with aspects of the techniques described herein. The order in which the method blocks are described are not intended to be construed as a limitation, and any number of the described method blocks can be combined in any order to implement a method, or an alternate method.

At block 302, one or more of a thermal state or a battery power level of a UE is detected. For example, the UE 102 can detect a temperature level of the UE 102 indicating a current temperature of a housing of the UE 102 or of one or more mechanical components of the UE 102. Alternatively or in addition, the UE 102 can detect a power level of a battery of the UE 102, indicating a current charge of the battery.

At block 304, the thermal state of the UE is determined to be greater than a threshold temperature value or the battery power level is determined to be less than a threshold power level. For example, the UE 102 can determine that the UE is operating at a temperature that may be perceived by a user as too hot, or that the housing of the UE is currently at a temperature that is perceived by the user as too hot. Any suitable temperature threshold value may be used to indicate that the UE 102 should enter a low-power mode to reduce power consumption and temperature. The perceived temperature may be based on the threshold temperature value, which may be predefined by the base station 104 or by the UE 102 itself (e.g., based on a previous user-selected setting). In an example, the UE 102 can determine that the power level of the battery is below a certain threshold value, such as 50%, 35%, 20%, 10%, 5%, and so on. Any suitable threshold value can be used to indicate whether the UE 102 should enter a low-power mode to reduce power consumption and conserve battery power.

At block 306, a fast low-power mode (FLPM) request message is generated in response to the determination in block 304. For example, when the UE 102 determines that the thermal state is greater than the threshold temperature value or the battery power level is less than the threshold power level, the UE 102 responsively generates an FLPM request message to request to enter a low-power mode. Alternatively, the FLPM request message can be generated in response to a user input at the UE 102. The FLPM may include an inactive mode or an idle mode. In the inactive mode (RCC_inactive), the UE 102 maintains a configured UE-specific resume-Radio Network Temporary Identity (RNTI), which is usable by the base station for UE-specific control signaling. In the idle mode (RCC_idle), however, the RNTI is not maintained and to reconnect with the base station, the UE is required to perform a full-service request procedure.

In aspects, the UE 102 can indicate via the FLPM request message that only certain priority Internet Protocol (IP) flow may be used as a basis to wake the UE 102 from the low-power mode. For example, the UE 102 can set a priority level for particular IP flow, such as specific types of communications (e.g., voice call, SMS message, emergency call) or sources (e.g., spouse, employer, hospital), that should wake the UE from the inactive or idle mode. Accordingly, while the UE is in the low-power mode, transmissions associated with other types of communications or sources may be delayed. In an example, such transmissions may be delayed for a predefined period of time or until a number (e.g., user configured or predefined) of communications have been aggregated. Any suitable number of priority levels can be utilized. For example, the UE 102 can indicate priority for certain communication types or sources while leaving all other communications as not priority. Alternatively, a high-priority level can be used for communications that are to wake the UE 102 and a low-priority level can be used for communications that are to be delayed so as to not wake the UE 102, such as to prevent low priority communications from causing additional power consumption at the UE 102.

At block 308, a UL signal including the FLPM request message is transmitted to a base station. For example, the UE 102 transmits the UL signal to the base station 104 via the wireless link 106. In aspects, the FLPM request message requests permission for the UE to enter a low-power mode, such as the inactive mode or idle mode. In at least one example, the UE 102 can use separate messages or flags to choose to remain in one of the inactive or idle modes.

At block 310, a downlink (DL) signal is detected that includes an FLPM acknowledgment (ACK) from the base station. For example, the UE 102 can detect a DL signal from the base station 104 via the wireless link 106. In at least one example, the DL signal includes instructions to cause the UE 102 to enter the low-power mode. The low-power mode may be the specifically requested low-power mode, such as the inactive mode. In one example, the instructions may cause the UE 102 to enter a different low-power mode, such as the inactive mode when the UE 102 requested to enter the idle mode.

At block 312, the low-power mode is initiated based on the instructions received from the base station. For example, the UE 102 is forced to enter the low-power mode dictated by the base station 104, regardless of which mode the UE 102 requested to enter. Alternately or additionally, an indication of the low-power mode (e.g., at initiation, during, or at exit) can be provided via a display, speaker, and/or vibrational generator of the UE 102.

FIG. 4 depicts an example method 400 for triggering a fast low-power mode at a UE in accordance with aspects of the techniques described herein. The order in which the method blocks are described are not intended to be construed as a limitation, and any number of the described method blocks can be combined in any order to implement a method, or an alternate method.

At block 402, an FLPM request message is received from a UE. For example, the base station 104 may receive the FLPM request message from the UE 102 via the wireless link 106. The FLPM request message may be received via any suitable uplink signal or control channel of the wireless link or wireless connection.

At block 404, the FLPM request message is decoded. In aspects, the FLPM request message includes a request that the UE enter a low-power mode. In addition, the FLPM request message may include an indication of a thermal state or a battery power level of the UE, to inform the base station 104 that the UE should reduce power consumption because the UE is operating at potentially unsafe temperatures or with a low battery. Alternatively or in addition, the FLPM request message may indicate which low-power mode (e.g., inactive mode or idle mode) that the UE 102 is requesting. In an example, the FLPM request message may indicate priority IP flow that may be used to wake the UE 102 while the UE 102 is in the low-power mode. Other IP flow, such as IP flow that is not included in the priority IP flow or is categorized as low-priority IP flow, may be throttled back (e.g., delayed or buffered) for a period of time. Such communications can be aggregated and subsequently transmitted in a group to the UE 102.

At block 406, an FLPM-ACK corresponding to the FLPM request message is generated. For example, the base station 104 generates the FLPM acknowledgment to permit the UE 102 to enter a low-power mode, such as the requested low-power mode or a different low-power mode.

At block 408, a DL signal including the FLPM-ACK is transmitted to cause the UE to enter the low-power mode. For example, the base station 104 can transmit the FLPM-ACK via a DL signal such as MAC CE or a downlink control information (DCI).

Blocks 410-418 represent optional method blocks that may be performed while the UE 102 is in the low-power mode. At block 410, a communication is received to transmit to the UE. For example, the base station 104 may receive via the core network a communication, such as a voice call or SMS message, addressed to the UE 102. If the FLPM request message indicated a requested wakeup delay (e.g., frequency of waking the UE 102), then at 412, transmission of the communication is delayed for a duration of time. The duration of time can be any suitable duration of time (e.g., 1.0 seconds, 2.5 seconds, 5.0 seconds, 60 seconds, etc.). For instance, the UE 102 may indicate that it is preferable to delay one minute for an SMS message. In an example, the duration of time is specified by the UE 102 in the FLPM request message. Alternatively, the base station 104 can set a time of delay for the wakeup of the UE 102.

At block 414, a type or source of the communication is determined to correspond to priority information included in the FLPM request message. Some examples include the base station 104 determining that the IP flow is a priority voice call from the user's spouse, a high-priority email from the user's employer, a priority SMS message from the user's child, or an emergency call. Other examples include the base station determining that the IP flow is a low-priority voice call from an unknown caller ID or a low-priority email corresponding to a service to which the user is subscribed.

If the communication is a high-priority communication, at block 416, then the base station 104 transmits a DL signal to wake the UE 102 from the low-power mode to receive the communication. In aspects, the base station 104 can instruct the UE 102 to return to the low-power mode after completion of the transmission of the communication. This may be based on a previous indication by the UE 102 in the FLPM request message to remain in the low-power mode. Alternatively, the base station 104 can determine that the UE 102 should remain in the low-power mode based on one or more other factors, such as a time of day, a location of the UE, network traffic, and so on.

If the communication is a low-priority communication, then at block 418, the base station 104 delays transmission to the UE 102 so as to not wake the UE 102. The duration of the delay may be based on a determination by the base station 104 or based on a request by the UE 102. In an example, the base station 104 can aggregate all incoming communications for the UE 102 during the delay and then transmit all of the aggregated messages when the delay expires, such as at a scheduled periodic wakeup.

### Example Device

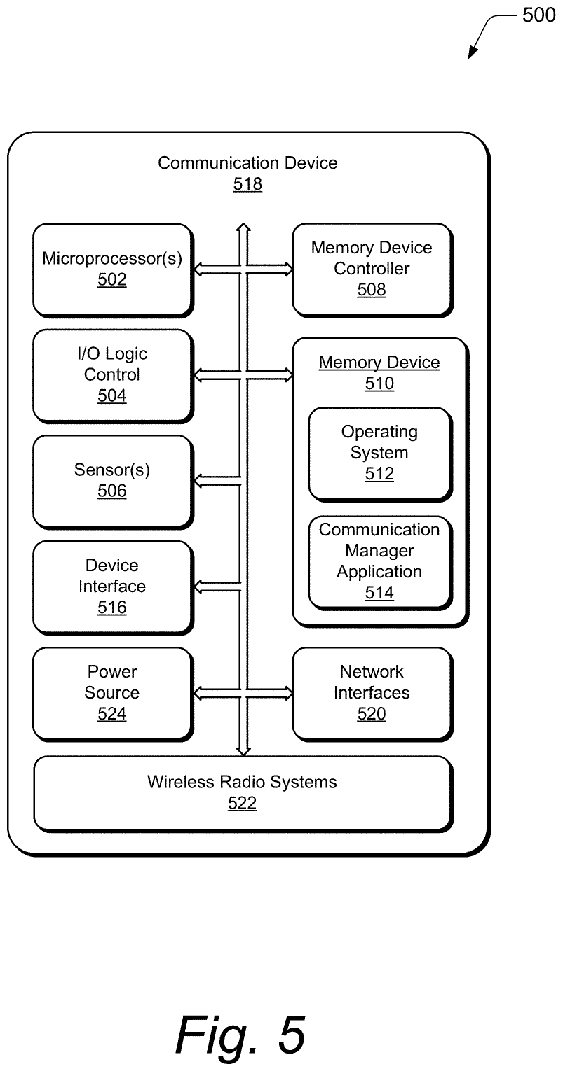

FIG. 5 illustrates an example communication device 500 that can be implemented as the user equipment 102 in accordance with one or more aspects of a 5G NR fast low-power mode as described herein. The example communication device 500 may be any type of mobile communication device, computing device, client device, mobile phone, tablet, communication, entertainment, gaming, media playback, and/or other type of device.

The communication device 500 can be integrated with electronic circuitry, microprocessors, memory, input output (I/O) logic control, communication interfaces and components, as well as other hardware, firmware, and/or software to implement the device. Further, the communication device 500 can be implemented with various components, such as with any number and combination of different components as further described with reference to the user equipment 102 shown in FIGS. 1 and 2.

In this example, the communication device 500 includes one or more microprocessors 502 (e.g., microcontrollers or digital signal processors) that process executable instructions. The device also includes an input-output (I/O) logic control 504 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits.

The one or more sensors 506 can be implemented to detect various properties such as acceleration, temperature, humidity, supplied power, proximity, external motion, device motion, sound signals, ultrasound signals, light signals, global-positioning-satellite (GPS) signals, radio frequency (RF), other electromagnetic signals or fields, or the like. As such, the sensors 506 may include any one or a combination of temperature sensors, humidity sensors, accelerometers, microphones, optical sensors up to and including cameras (e.g., charged coupled-device or video cameras), active or passive radiation sensors, GPS receivers, and radio frequency identification detectors.

The communication device 500 includes a memory device controller 508 and a memory device 510 (e.g., the computer-readable storage media 212), such as any type of a nonvolatile memory and/or other suitable electronic data storage device. The communication device 500 can also include various firmware and/or software, such as an operating system 512 that is maintained as computer-executable instructions by the memory and executed by a microprocessor. The device software may also include a communication manager application 514, such as an instance of the FLPM manager 215, for implementing aspects of a 5G NR fast low-power mode. The computer-readable storage media described herein excludes propagating signals or carrier waves.

The communication device 500 also includes a device interface 516 to interface with another device or peripheral component. In addition, the communication device 500 includes an integrated data bus 518 that couples the various components of the communication device 500 for data communication between the components. The data bus 518 in the communication device 500 may also be implemented as any one or a combination of different bus structures and/or bus architectures.

The device interface 516 may receive input from a user and/or provide information to the user (e.g., as a user interface), and a received input can be used to determine a setting, such as to initiate or enter a FLPM in accordance with one or more aspects. The device interface 516 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 516 may also receive inputs from any number of peripherals, such as buttons, a keypad, a switch, a microphone, and an imager (e.g., a camera device).

The communication device 500 can include network interfaces 520, such as a wired and/or wireless interface for communication with other devices via Wireless Local Area Networks (WLANs), wireless Personal Area Networks (PANs), and for network communication, such as via the Internet. The network interfaces 520 may include Wi-Fi, Bluetooth™, BLE, and/or IEEE 502.18.4. The communication device 500 also includes wireless radio systems 522 for wireless communication with cellular and/or mobile broadband networks. Each of the different radio systems can include a radio device, antenna, and chipset that is implemented for a particular wireless communications technology, such as the antennas 202, the RF front end 204, the LTE transceiver 206, and/or the 5G NR transceiver 208. The communication device 500 also includes a power source 524, such as a battery and/or to connect the device to line voltage. An AC power source may also be used to charge the battery of the device.

Although aspects of a 5G NR fast low-power mode have been described in language specific to features and/or methods, the subject of the appended claims is not necessarily limited to the specific features or methods described. Rather, the specific features and methods are disclosed as example implementations of a 5G NR fast low-power mode, and other equivalent features and methods are intended to be within the scope of the appended claims. Further, various different aspects are described, and it is to be appreciated that each described aspect can be implemented independently or in connection with one or more other described aspects.

A first method for autonomously triggering a fast low-power mode at a user equipment is described. The first method comprises: transmitting, by the user equipment, an uplink signal that includes a fast low-power mode request message to a base station, the fast low-power mode request message requesting permission for the user equipment to enter a radio-resource-control idle mode; detecting, at the user equipment, a downlink signal that includes a fast low-power mode acknowledgment from the base station, the downlink signal including instructions to direct the user equipment to instead enter a radio-resource-control inactive mode; and initiating, at the user equipment, the radio-resource-control inactive mode based on the instructions received from the base station.

In addition to the above described first method, in a second method the uplink signal includes one or more of Radio Resource Control messages, a Medium Access Control Control Element, or an Uplink Control Information. In addition to the above described first method, in a third method the uplink signal includes an indication of a desired wakeup delay based on a type or source of an Internet Protocol flow. In addition to the above described first method, in a fourth method the uplink signal includes an indication of a desired wakeup delay based on a number of communications that have been aggregated at the base station. In addition to the above described first method, in a fifth method the uplink signal includes a request for waking the user equipment only for a communication type or source having a high priority level. In addition to the above described first method, in a sixth method the uplink signal includes: an indication of one or more communication types or sources corresponding to a low priority level; and a request to not wake the user equipment for communications corresponding to the one or more communication types or sources while the user equipment is in the radio-resource-control idle mode or the radio-resource-control inactive mode.

In addition to any of the first, second, third, fourth, fifth, or sixth methods described above, a seventh method comprises: detecting, by the user equipment, an additional downlink signal to wake the user equipment from the radio-resource-control inactive mode to receive a high-priority communication, the additional downlink signal including additional instructions for the user equipment to return to the radio-resource-control inactive mode after receiving the high-priority communication; and after receiving the high-priority communication, re-initiating the radio-resource-control inactive mode based on the additional instructions in the additional downlink signal received from the base station.

In addition to the seventh method described above, in an eighth method the additional instructions to return to the radio-resource-control inactive mode are based on a previous indication by the user equipment in the fast low-power mode request message to remain the radio-resource-control idle mode.

In addition to the first method described above, in a ninth method the uplink signal is transmitted based on one or more of a battery power or a thermal state of the user equipment. In addition to the first or ninth method described above, a tenth method comprises: detecting one or more of a thermal state or a battery power level of the user equipment; determining that the thermal state of the user equipment is greater than a threshold temperature value or that the battery power level is less than a threshold power level; and generating the fast low-power mode request message for transmission via the UL signal in response to the determination.

A mobile communication device comprises a processor and memory system configured to implement a fast low-power mode manager application, the fast low-power mode manager application configured to execute any of the first to tenth methods.

An eleventh method for triggering a fast low-power mode at a user equipment is described. The ninth method comprises: receiving, at a base station, a fast low-power mode request message from the user equipment; decoding the fast low-power mode request message, the fast low-power mode request message requesting that the user equipment enter a radio-resource-control idle mode; generating a fast low-power mode acknowledgment corresponding to the fast low-power mode request message; and transmitting, from the base station, a downlink signal to the user equipment including the fast low-power mode acknowledgment to direct the user equipment to instead enter a radio-resource-control inactive mode.

In addition to the eleventh method described above, in a twelfth method the fast low-power mode request message received from the user equipment is included in one or more of Radio Resource Control messages, a Medium Access Control Control Element, or an Uplink Control Information. In addition to the eleventh method described above, in a thirteenth method the fast low-power mode request message includes an indication of a desired wakeup delay based on a type or source of an Internet Protocol flow. In addition to the eleventh method described above, in a fourteenth method the fast low-power mode request message includes an indication of a desired wakeup delay based on a number of communications that have been aggregated at the base station. In addition to the eleventh method described above, in a fifteenth method the fast low-power mode request message includes: an indication of one or more communication types or sources corresponding to a low priority level; and a request to not wake the user equipment for communications corresponding to the one or more communication types or sources while the user equipment is in the radio-resource-control idle mode. In addition to any of the eleventh to fifteenth methods described above, a sixteenth method includes determining, by the base station, that the user equipment should return to the radio-resource-control inactive mode after receiving a high-priority communication; and transmitting an additional downlink signal to wake the user equipment to receive the high-priority communication, the additional downlink signal including instructions to return to the radio-resource-control inactive mode after receiving the high-priority communication.

In addition to any of the eleventh to sixteenth methods described above, in a seventeenth method the fast low-power mode request message includes an indication of one or more of a battery power level or a thermal state of the user equipment. In addition to any of the eleventh to seventeenth methods described above, in an eighteenth method the fast low-power mode request message includes an indication that a battery power level of the user equipment is less than a threshold power level or a thermal state of the user equipment is greater than a threshold temperature value.

A base station comprises: a radio frequency transceiver configured to transmit and receive communication signals with a user equipment; and a processor and memory system configured to implement a base station manager application, the base station manager application configured to execute any of the eleventh to eighteenth methods.

1. A method for autonomously triggering a fast low-power mode at a user equipment, the method comprising:
transmitting, by the user equipment, an uplink signal that includes a fast low-power mode request message to a base station, the fast low-power mode request message requesting permission for the user equipment to enter a radio-resource-control idle mode;
detecting, at the user equipment, a downlink signal that includes a fast low-power mode acknowledgment from the base station, the downlink signal including instructions to direct the user equipment to instead enter a radio-resource-control inactive mode; and
initiating, at the user equipment, the radio-resource-control inactive mode based on the instructions received from the base station.

2. The method as recited in claim 1, wherein the uplink signal includes one or more of Radio Resource Control messages, a Medium Access Control (MAC) Control Element, or an Uplink Control Information.

3. The method as recited in claim 1, wherein the uplink signal includes an indication of a desired wakeup delay based on a type or source of an Internet Protocol flow.

4. The method as recited in claim 1, wherein the uplink signal includes an indication of a desired wakeup delay based on a number of communications that have been aggregated at the base station.

5. The method as recited in claim 1, wherein the uplink signal includes a request for waking the user equipment only for a communication type or source having a high priority level.

6. The method as recited in claim 1, wherein the uplink signal includes:
an indication of one or more communication types or sources corresponding to a low priority level; and
a request to not wake the user equipment for communications corresponding to the one or more communication types or sources while the user equipment is in the radio-resource-control idle mode or the radio-resource-control inactive mode.

7. The method as recited in claim 1, further comprising:
detecting, by the user equipment, an additional downlink signal to wake the user equipment from the radio-resource-control inactive mode to receive a high-priority communication, the additional downlink signal including additional instructions for the user equipment to return to the radio-resource-control inactive mode after receiving the high-priority communication; and
after receiving the high-priority communication, re-initiating the radio-resource-control inactive mode based on the additional instructions in the additional downlink signal received from the base station.

8. The method as recited in claim 7, wherein the additional instructions to return to the radio-resource-control inactive mode are based on a previous indication by the user equipment in the fast low-power mode request message to remain the radio-resource-control idle mode.

9. A mobile communication device comprising:
a processor and memory system configured to implement a fast low-power mode manager application, the fast low-power mode manager application configured to execute a method comprising:
transmitting, by the mobile communication device, an uplink signal that includes a fast low-power mode request message to a base station, the fast low-power mode request message requesting permission for the mobile communication device to enter a radio-resource-control idle mode;
detecting, at the mobile communication device, a downlink signal that includes a fast low-power mode acknowledgment from the base station, the downlink signal including instructions to direct the mobile communication device to instead enter a radio-resource-control inactive mode; and
initiating, at the mobile communication device, the radio-resource-control inactive mode based on the instructions received from the base station.

10. A method for triggering a fast low-power mode at a user equipment, the method comprising:
receiving, at a base station, a fast low-power mode request message from the user equipment;
decoding the fast low-power mode request message, the fast low-power mode request message requesting that the user equipment enter a radio-resource-control idle mode;
generating a fast low-power mode acknowledgment corresponding to the fast low-power mode request message; and
transmitting, from the base station, a downlink signal to the user equipment including the fast low-power mode acknowledgment to direct the user equipment to instead enter a radio-resource-control inactive mode.

11. The method as recited in claim 10, wherein the fast low-power mode request message received from the user equipment is included in one or more of Radio Resource Control messages, a Medium Access Control (MAC) Control Element, or an Uplink Control Information.

12. The method as recited in claim 10, wherein the fast low-power mode request message includes an indication of a desired wakeup delay based on a type or source of an Internet Protocol flow.

13. The method as recited in claim 10, wherein the fast low-power mode request message includes an indication of a desired wakeup delay based on a number of communications that have been aggregated at the base station.

14. The method as recited in claim 10, wherein the fast low-power mode request message includes:
an indication of one or more communication types or sources corresponding to a low priority level; and
a request to not wake the user equipment for communications corresponding to the one or more communication types or sources while the user equipment is in the radio-resource-control idle mode.

15. The method as recited in claim 10, further comprising:
determining, by the base station, that the user equipment should return to the radio-resource-control inactive mode after receiving a high-priority communication; and
transmitting an additional downlink signal to wake the user equipment to receive the high-priority communication, the additional downlink signal including instructions to return to the radio-resource-control inactive mode after receiving the high-priority communication.

16. A base station comprising:
a radio frequency transceiver configured to transmit and receive communication signals with a user equipment; and
a processor and memory system configured to implement a base station manager application, the base station manager application configured to execute a method comprising:
receiving, at the base station, a fast low-power mode request message from the user equipment;
decoding the fast low-power mode request message, the fast low-power mode request message requesting that the user equipment enter a radio-resource-control idle mode;
generating a fast low-power mode acknowledgment corresponding to the fast low-power mode request message; and
transmitting, from the base station, a downlink signal to the user equipment including the fast low-power mode acknowledgment to direct the user equipment to instead enter a radio-resource-control inactive mode.

17. The base station as recited in claim 16, wherein the fast low-power mode request message received from the user equipment is included in one or more of Radio Resource Control messages, a Medium Access Control (MAC) Control Element, or an Uplink Control Information.

18. The base station as recited in claim 16, wherein the fast low-power mode request message includes an indication of a desired wakeup delay based on:
a type or source of an Internet Protocol flow; or
a number of communications that have been aggregated at the base station.

19. The base station as recited in claim 16, wherein the fast low-power mode request message includes:
an indication of one or more communication types or sources corresponding to a low priority level; and
a request to not wake the user equipment for communications corresponding to the one or more communication types or sources while the user equipment is in the radio-resource-control idle mode.

20. The base station as recited in claim 16, further comprising:
determining, by the base station, that the user equipment should return to the radio-resource-control inactive mode after receiving a high-priority communication; and
transmitting an additional downlink signal to wake the user equipment to receive the high-priority communication, the additional downlink signal including instructions to return to the radio-resource-control inactive mode after receiving the high-priority communication.
